(19) United States
(12) Patent Application Publication
(10) Pub. No.: US 2010/0290319 A1
(43) Pub. Date: Nov. 18, 2010

(54) Methods and Apparatus for Self-Assembled Time-Keeping Device

(76) Inventors: Robert Swartz, Highland Park, IL (US); Peter Schmitt, Cambridge, MA (US)

Correspondence Address: Otis Patent Law, 1181 Wade Street, Highland Park, IL, 60035, US

(21) Appl. No.: 12/779,847

(22) Filed: May 13, 2010

Related U.S. Application Data
(60) Provisional application No. 61/178,041, filed on May 13, 2009.

(51) Int. Cl. G04G 9/00; G06F 17/50; G04D 3/00

(52) U.S. Cl. 368/62; 700/98; 700/120; 29/896.3; 700/119; 700/212

(57) ABSTRACT

In illustrative implementations of this invention, a mechanical clock is produced in a manner such that, once its separate parts are made, the clock requires no further assembly. In one implementation of this invention, a mechanical clock is designed using standard CAD (computer-aided design) modeling tools and made with a rapid prototyping machine. The support material used in rapid prototyping is then removed. Once the support material is removed, the clock runs without any additional assembly. In this implementation, the clock contains all the components that are required and they are all constructed in the rapid prototyping process.

### CROSS-REFERENCE TO RELATED APPLICATION

This application claims the benefit of U.S. Provisional Application Ser. No. 61/178,041, filed May 13, 2009, the entire disclosure of which is herein incorporated by reference.

### FIELD OF THE INVENTION

This invention relates generally to time-keeping devices.

### BACKGROUND OF THE INVENTION

The mechanical clock represents a pinnacle of mechanical design with its many parts, such as gears, escapement and other parts. Traditionally, these parts require complex assembly.

### SUMMARY

In illustrative implementations of this invention, a mechanical clock is produced in a manner such that, once its separate parts are made, the clock requires no further assembly. Thus, the clock can be said to be manufactured in a “self-assembled” manner or “without assembly”.

In one implementation of this invention, a mechanical clock is designed using standard CAD (computer-aided design) modeling tools and made with a rapid prototyping machine. The support material used in rapid prototyping is then removed. Once the support material is removed, the clock runs without any additional assembly. The clock contains all the components that are required and they are all constructed in the rapid prototyping process.

It should be understood that, in addition to the production of a clock, the methods, apparatus and compositions of matter of the present invention can be applied to the production of many other mechanical time-keeping devices.

### BRIEF DESCRIPTION OF THE DRAWINGS

FIG. 1 is a diagram illustrating steps in a process of producing a time-keeping device without assembly, in an illustrative implementation of this invention.

FIG. 2 is a front view of a clock manufactured without assembly, in an illustrative implementation of this invention.

### DETAILED DESCRIPTION

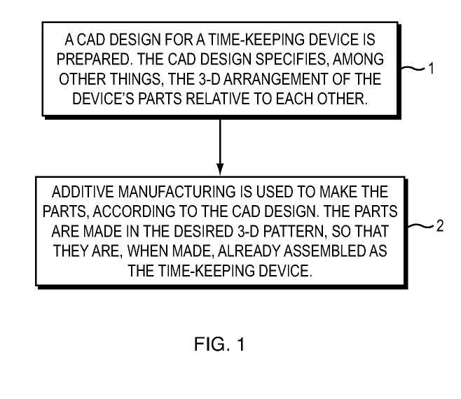

FIG. 1 shows steps of manufacturing a time-keeping device without assembly, in an illustrative implementation of this invention. The machine is designed using a CAD program 1. The CAD design specifies the shape of the components of the machine. It also specifies a three-dimensional arrangement of the components relative to each other, in which the components are to be manufactured. Additive manufacturing is used to make components of the machine, according to the CAD design 2. The components are made in the desired three dimensional pattern, so that they are, when made, already assembled as a time-keeping device.

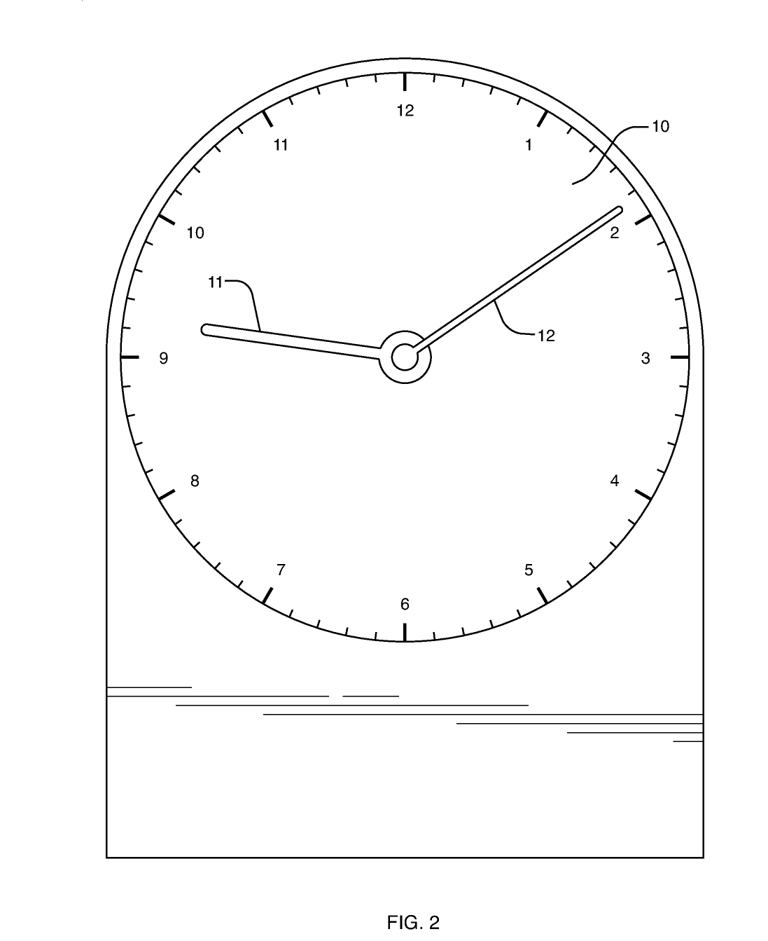

FIG. 2 shows a front view of a clock that may be manufactured without assembly, in an illustrative implementation of this invention. The clock includes a clock face 10 with markings for hours and minutes. An hour hand 11 and minute hand 12 are used to display the time.

In illustrative implementations of this invention, a clock is designed using the Rhino® CAD program from Robert McNeel Associates, Seattle Wash. Alternatively, other CAD programs or other 3D modeling software may be used. For example, the Solidworks® program from Dassault Systemes SolidWorks Corporation, Concord, Mass., may be used.

In illustrative implementations of this invention, components of the clock are physically produced by additive manufacturing. For example, a type of additive manufacturing that may be used is fused deposition manufacturing (FD). An “FD printer” means a machine for producing item by fused deposition manufacturing, and “FD printing” an item means producing that item by FD. FD printing is a well known method of rapid prototyping.

In illustrative implementations of this invention, a CAD design allows for the clock to be FD printed. For example, hollow parts may have one or more holes to allow for the support material to be removed after FD printing. Also, for example, separate parts that move relative to each other in the operation of the clock may be positioned in the CAD model so that they are not contiguous at the time of FD printing (to avoid the pieces fusing or being stuck to each other). Also, for example, if the FD printer in question can only use a single, homogeneous material, the design may allow for production of the entire clock with that single material. Also, for example, in order for the CAD design to allow the clock to be produced within the build area of an FD printer, the CAD design may need to be modified to shorten or reposition certain parts.

In some cases, an existing design for a mechanical clock may be modified to allow for it to be produced by additive manufacturing. Existing designs for mechanical clocks are well known. Examples are set forth in the book “Make Your Own Working Paper Clock” by Rudolph, James Smith and in the web site Wooden-Gear-Clocks.com, 1407 Lynn Avenue, Altoona, Wis. 54720, http://www.wooden-gear-clocks.com/plan_description.htm. These sources give designs for clock construction, and contemplate making the clock in a manner that requires assembly. The parts of a clock made with such an existing plan can be measured with a caliper or other tool. A CAD program can be used to create a design for the clock that is based on these measurements. In an illustrative implementation of this invention, the existing design may be modified to allow for FD printing. For example, if the pendulum in the existing design is too large to fit in the build area, the gears and the pendulum may be modified so that the pendulum fits in the build area. Also, for example, an existing plan may use a string to hold the weight that drives the clock. However, strings cannot be easily fabricated in many FD printers. A chain can be substituted for the string so that it can be made with a FD printer. Alternatively, the clock can be designed without starting from an existing design.

In an illustrative implementation of this invention, after clock elements or parts are entered into the CAD program they are placed in their proper position in the CAD model, which corresponds to where they will reside when produced by additive manufacturing as a physical clock.

In some implementations, the clock uses gravity for its power and uses a pendulum to provide periodic input, as follows: A chain, rather than string, is used to hold the weight that powers the clock. Holes are provided in the chain (and other parts of the clock) to allow the support material used in the FD printing process to be removed. The teeth of the gears have sufficient clearance between them so that they do not fuse and the support material can be removed. For gears that rotate on a bearing surface, there is clearance between the gear and the bearing surface and at least one opening through which the support material can be removed. A ratchet mechanism may prevent the chain holding the weight from slipping. This mechanism may use the fact that the plastic material used in FD printing can be deformed.

In an illustrative implementation of this invention, care must be taken in the placement of the escapement and the gear that is regulated (struck) by the escapement. For example, there must be enough clearance that the two parts do not fuse and the support material can be removed, and yet the clearance must be sufficiently small that the escapement will work properly. Also, for example, the minute hand and hour hand each may have an axle, one of which is inside the other. Holes may be placed in the outer axle so that support material can be removed. Holes may also placed in other parts of the clock (such as the links of the chain) to enable removal of support material at the end of FD printing. The pendulum weight may be hollow so that ball bearings, sand or other material can be added if the weight is insufficient to drive the gears, which in turn depends on what kind of printing material is used.

In an illustrative implementation of this invention, the chain can be wrapped around the main body of the clock in the virtual design, so that it fits within the build area of the FD printer when it is produced. In some implementations, the position of the weight on the pendulum can be adjusted. This is advantageous, because the regulation of the clock relies on the period of the pendulum, which in turn depends on the force of gravity where the clock is located, which force varies for different altitudes. By adjusting the position of the weight on the pendulum, one can adjust for different altitudes. Alternatively, many other designs of a clock and its parts may be used.

Once the design has been entered into the CAD program the clock can be printed. Care must be taken in the design so that the clock is sized to fit within the build envelope of the printer and the relationship of the parts is appropriate for the size of the clock being built. As the size of the clock changes certain structures and dimensions may need to be changed. If in the CAD program the dimensions may be parameterized this can simplify this process. Care may also be taken that all surfaces are closed otherwise there may be difficulty printing the clock.

In illustrative implementations of this invention, clock elements are made by fused deposition (FD) with a Dimension® Elite Printer from Stratasys, Inc., Eden Prairie, Minn. This machine uses a thermoplastic material that has desirable properties to produce the clock parts. Alternatively, other additive manufacturing techniques may be used, rather than FD. For example, components of a clock may be made by additive manufacturing with a ProJet® machine (which uses UV curable photo polymers) or with the Sinterstation® (which laser sinters polymer powders). Other additive manufacturing techniques that may be used to implement this invention include layer manufacturing, freeform fabrication and aerosol jetting.

In an illustrative implementation of this invention, using the CAD program, the file of the clock can be saved as an STL file. This file is then transferred to an FD printer and the program that drives the FD printer is used to open the file. The virtual clock is then placed on the build area and positioned in an appropriate manner. After the appropriate steps according to particular manufacturer's instructions are followed the computer is instructed to print the clock. The printer hardware is also set up to follow these instructions. After the machine has finished printing the clock, it is removed from the FD printer. Following the manufacturer instructions, the support material is removed. For example, in the case of a Dimension® Elite Printer, the assembly is put in a special ultrasonic water bath in order to remove the support material. Or, for example, if one is using a light curable photopolymer machine, then the clock is put in an oil bath or oven and the wax support is melted away. Once the support material is removed, the clock can be placed on a wall or other location, and the pendulum weight can be raised (by pulling on a chain) to provide power for the clock. The clock can be regulated to give accurate time.

One of the major advances of this invention relates to the cost of assembly, i.e., the cost of assembling separate parts after they have been made. In the past there was a direct relationship between manufacturing cost and the time and complexity of assembly. Using the techniques described, the cost of assembly can be eliminated.

In illustrative implementations of this invention, “assembly” needs to be done only once, in the course of designing the CAD model, and then in the additive manufacturing process no additional assembly is required. The clock using these techniques is self assembled. This is a significant change from clock manufacture in the past which requires significant hand or mechanized assembly.

It should be clear that there are many time-keeping devices where the same methods and principles can be used. For example, this invention may be used to manufacture clocks, chronometers, watches, stop watches and timers.

Although in many implementations, no assembly is required after the separate parts are made, one can build devices which require minimal additional assembly using the principles of this invention. For example, rather than using gravity as the power source for a clock, other power sources such as a spring or motor may be used. In that case, the clock may require the addition of a spring to drive the escapement, or an electric motor, which additional parts could be added with minimal assembly. For example, this invention may be implemented to manufacture a watch or stop watch. In that case: (1) the parts made by additive manufacture without assembly may include a balance wheel and regulator lever, and (2) a balance spring is an additional part that may be added later by assembly. Or, for example, this invention may be implemented to manufacture an electro-mechanical clock. In that case: (1) the parts made by additive manufacturing without assembly may include mechanical parts of the clock, and (2) an electrical motor is an additional part that may added later by assembly.

Advantageously, this invention may be used to produce customizable timepieces. For example, by varying one or more elements of a CAD design, one could cause the timepieces produced by this invention to each differ from the others. For example, a personal message could be inscribed on a surface of a clock. The message may differ from clock to clock. Or, for example, an image of person or animal may be produced (e.g., in relief or intaglio, or with shades or colors) on a surface of a watch. This image may be different for each watch.

This invention may be implemented in many different ways. Here are some examples:

This invention may be implemented as a method of producing a time-keeping device, wherein: (a) some or all of the components of said device are made by additive manufacturing in such a manner that said components are, when so made, already assembled as all or part of said time-keeping device, (b) said device is adapted for measuring the passage of time in such a way that said measurement is effected, at least in part, by movement of at least one said component, and (c) said device is adapted for displaying time. Furthermore: (1) said device may comprise a clock, (2) said device may comprise a watch or stop watch, (3) said device may comprise a time-keeping device that is powered by tension in a spring or by gravity, (4) said method may be adapted to allow production of customizable time-keeping devices, which differ slightly from each other, by varying at least one element in the CAD design for said devices, (5) said additive manufacturing may involve fused deposition, (5) said additive manufacturing may involve curing a photopolymer with light, (6) said additive manufacturing may involve laser sintering, (7) said additive manufacturing may time-keeping device is adapted for visually displaying time in one or more of the following units: years, months, weeks, days, hours, minutes, seconds, fractions of seconds, or other units of time, (8) said additive manufacturing may involve rapid prototyping, (9) said components may comprise only part of said time-keeping device, and other components may need to be added by assembly or otherwise to complete said time-keeping device, (10) said components made by additive manufacturing may include a balance wheel, and a balance spring may be added later by assembly. (11) said measurement of time may be effected, at least in part, by analog computation, (12) said measurement of time may be effected, at least in part, by digital computation, and (13) said method may further comprise a step of transferring a CAD design to an additive manufacturing machine as a STL file.

This invention may be implemented as a time-keeping apparatus comprising a plurality of components, wherein: (a) some or all of the components of said apparatus are made by additive manufacturing in such a manner that said components are, when so made, already assembled as all or part of said time-keeping mechanism, (b) said apparatus is adapted for measuring the passage of time in such a way that said measurement is effected, at least in part, by movement of at least one said component, and (c) said apparatus is adapted for displaying time. Furthermore: (1) said components may comprise only part of said time-keeping device, and other components may need to be added by assembly or otherwise to complete said time-keeping device, (2) said apparatus may be adapted to display time using an hour hand and minute hand, (3)said apparatus may be adapted for visually displaying time in one or more of the following units: years, months, weeks, days, hours, minutes, seconds, fractions of seconds, or other units of time, and (4) said apparatus may be adapted for use as part of an electrically-powered time-keeping device.

### CONCLUSION

While illustrative implementations are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

What is claimed is:

1. A method of producing a time-keeping device, wherein:
some or all of the components of said device are made by additive manufacturing in such a manner that said components are, when so made, already assembled as all or part of said time-keeping device,
said device is adapted for measuring the passage of time in such a way that said measurement is effected, at least in part, by movement of at least one said component, and
said device is adapted for displaying time.

2. The method of claim 1, wherein said device comprises a clock.

3. The method of claim 1, wherein said device comprises a watch or stop watch.

4. The method of claim 1, wherein said device comprises a time-keeping device that is powered by tension in a spring or by gravity.

5. The method of claim 1, wherein said method is adapted to allow production of customizable time-keeping devices, which differ slightly from each other, by varying at least one element in the CAD design for said devices.

6. The method of claim 1, wherein said additive manufacturing involves fused deposition.

7. The method of claim 1, wherein said additive manufacturing involves curing a photopolymer with light.

8. The method of claim 1, wherein said additive manufacturing involves laser sintering.

9. The method of claim 1, wherein said time-keeping device is adapted for visually displaying time in one or more of the following units: years, months, weeks, days, hours, minutes, seconds, fractions of seconds, or other units of time.

10. The method of claim 1, wherein said additive manufacturing involves rapid prototyping.

11. The method of claim 1, wherein
said components comprise only part of said time-keeping device, and
other components must be added by assembly or otherwise to complete said time-keeping device.

12. The method of claim 11, wherein
said components made by additive manufacturing include a balance wheel, and
a balance spring is added later by assembly.

13. The method of claim 1, wherein said measurement of time is effected, at least in part, by analog computation.

14. The method of claim 1, wherein said measurement of time is effected, at least in part, by digital computation.

15. The method of claim 1, further comprising a step of transferring a CAD design to an additive manufacturing machine as a STL file.

16. A time-keeping apparatus comprising a plurality of components, wherein:
some or all of the components of said apparatus are made by additive manufacturing in such a manner that said components are, when so made, already assembled as all or part of said time-keeping mechanism,
said apparatus is adapted for measuring the passage of time in such a way that said measurement is effected, at least in part, by movement of at least one said component, and
said apparatus is adapted for displaying time.

17. The apparatus of claim 16, wherein:
said components comprise only part of said time-keeping device, and
other components must be added by assembly or otherwise to complete said time-keeping device.

18. The apparatus of claim 16, wherein said apparatus displays time using an hour hand and minute hand.

19. The apparatus of claim 16, wherein said apparatus is adapted for visually displaying time in one or more of the following units: years, months, weeks, days, hours, minutes, seconds, fractions of seconds, or other units of time.

20. The apparatus of claim 16, wherein said apparatus is part of an electrically-powered time-keeping device.
